(19) United States
(12) Patent Application Publication
(10) Pub. No.: US 2012/0049766 A1
(43) Pub. Date: Mar. 1, 2012

(54) Lighting Device Using Heterogeneous Light Sources

(76) Inventor: Yu-Chen Lin, Kaohsiung County (TW)

(21) Appl. No.: 12/862,399

(22) Filed: Aug. 24, 2010

(51) Int. Cl. H05B 37/02

(52) U.S. Cl. 315/313

(57) ABSTRACT

A lighting device includes a light fixture, a semiconductor light source and a gas-discharge light source mounted in the light fixture, and a controller disposed in the light fixture and connected electrically to the semiconductor light source and the gas-discharge light source. The controller is operable to control activation and deactivation of the semiconductor light source and the gas-discharge light source. Heat generated during operation of the semiconductor light source may increase the ambient temperature in the light fixture such that optimum performance of the gas-discharge light source may be ensured.

### BACKGROUND OF THE INVENTION

1. Field of the Invention

The invention relates to a lighting device, more particularly to a lighting device using heterogeneous light sources.

2. Description of the Related Art

Fluorescent lamps, such as thermionic emission fluorescent lamps and cold cathode fluorescent lamps, are suitable for providing wide-area illumination. However, when fluorescent lamps are used in a low-temperature environment, the brightness of light generated thereby is reduced, which necessitates the installation of a larger number of fluorescent lamp tubes to achieve a desired ambient brightness.

On the other hand, a lighting device may use light-emitting diodes, which emit directional light, as its light source. Light-emitting diodes are known to generate a large amount of heat during operation.

### SUMMARY OF THE INVENTION

The object of the present invention is to provide a lighting device using heterogeneous light sources which include a semiconductor light source and a gas-discharge light source.

According to the present invention, there is provided a lighting device that includes a light fixture, a semiconductor light source and a gas-discharge light source mounted in the light fixture, and a controller disposed in the light fixture and connected electrically to the semiconductor light source and the gas-discharge light source. The controller is operable to control activation and deactivation of the semiconductor light source and the gas-discharge light source.

According to the present invention, heat generated during operation of the semiconductor light source may increase the ambient temperature in the light fixture such that optimum performance of the gas-discharge light source may be ensured.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary perspective view of the first preferred embodiment of a lighting device using heterogeneous light sources according to the present invention;

FIG. 2 is a schematic bottom view of the first preferred embodiment;

FIG. 3 is a partly sectional view of the first preferred embodiment;

FIG. 4 is a perspective view of the second preferred embodiment of a lighting device using heterogeneous light sources according to the present invention; and

FIG. 5 is another perspective view of the second preferred embodiment to illustrate a transparent shield uncovering an open bottom side of a ceiling-mountable case.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

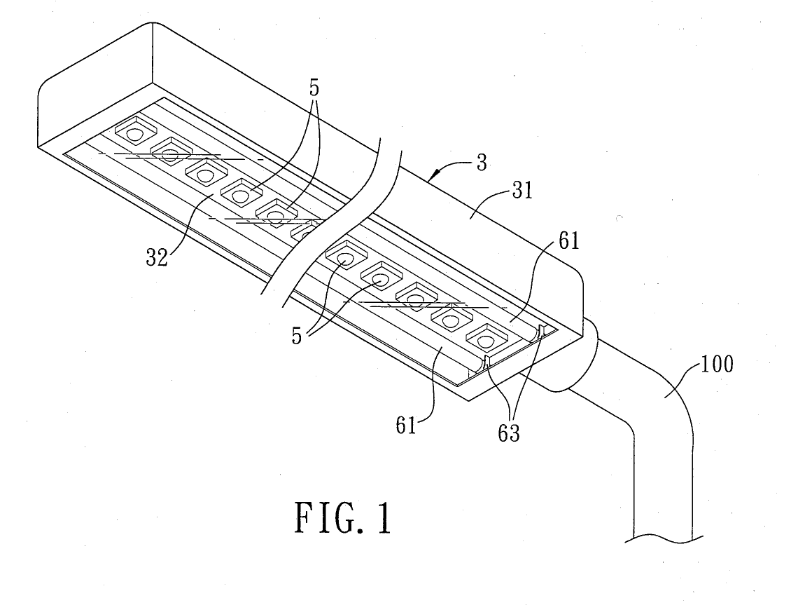

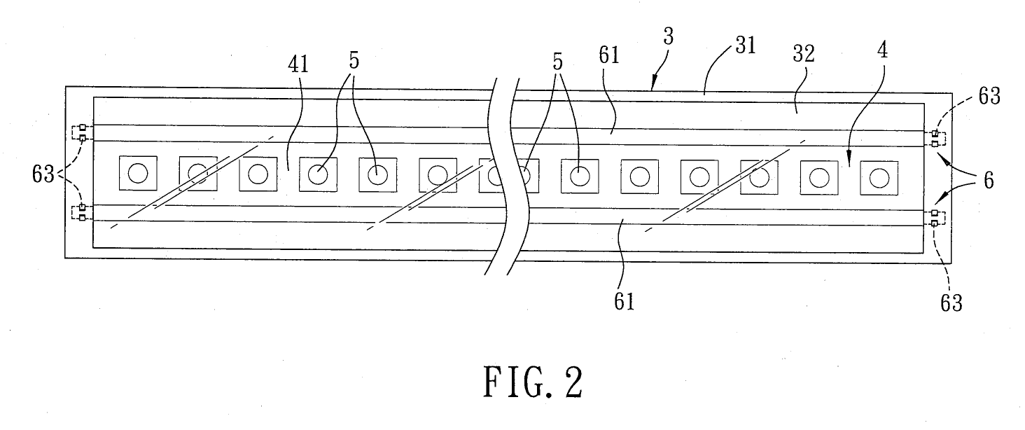

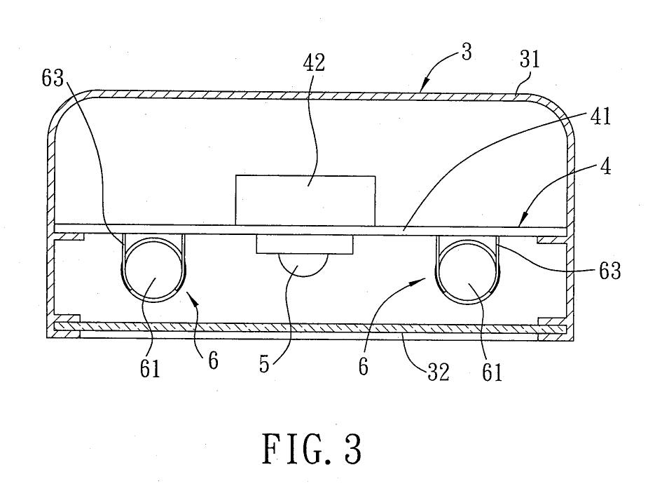

Referring to FIGS. 1 to 3, the first preferred embodiment of a lighting device according to the present invention is shown to include a light fixture 3, a semiconductor light source 4 mounted in the light fixture 3, a gas-discharge light source 6 mounted in the light fixture 3, and a controller 42 disposed in the light fixture 3. The controller 42 is connected electrically to the semiconductor light source 4 and the gas-discharge light source 6, and is operable to control activation and deactivation of the semiconductor light source 4 and the gas-discharge light source 6. The semiconductor light source 4 includes a circuit board 41 connected electrically to the controller 42, and a plurality of light emitting diodes 5 mounted on the circuit board 41. The gas-discharge light source 6 includes a fluorescent lamp tube 61 and a connector unit 63 to connect electrically the fluorescent lamp tube 61 to the controller 42. In this embodiment, the fluorescent lamp tube 61 has opposite ends connected to the controller 42 via the connector unit 63. The fluorescent lamp tube 61 may be a thermionic emission fluorescent lamp tube or a cold cathode fluorescent lamp tube.

Preferably, as best shown in FIG. 1, the light fixture 3 is adapted to be mounted on a top end of a lamp post 100 such that the lighting device can be used for roadside illumination. In this embodiment, the light fixture 3 includes a lampshade 31 that opens downwardly, and a transparent shield 32 that covers an open bottom side of the lampshade 31. The circuit board 41 is disposed in the light fixture 3. The controller 42 is mounted on an upper side of the circuit board 41, and the light emitting diodes 5 are mounted on a lower side of the circuit board 41 to emit downwardly oriented light. In this embodiment, there are two gas-discharge light sources 6 disposed at the lower side of the circuit board 41.

Preferably, the light-emitting diodes 5 are arranged on the circuit board 41 along a direction parallel to an extension direction of the fluorescent lamp tubes 61 of the gas-discharge light sources 6.

When the lighting device is used in a low-temperature environment, the controller 42 may be configured to activate the light emitting diodes 5 for emitting light for a predetermined time period before activating the fluorescent lamp tubes 61. The heat generated during operation of the light emitting diodes 5 increases the temperature in the light fixture 3 such that optimum brightness performance of the fluorescent lamp tubes 61 may be ensured once the fluorescent lamp tubes 61 are activated.

As mentioned hereinabove, the fluorescent lamp tubes 61 are suitable for wide-area illumination, whereas the light emitting diodes 5 are directional light sources. When the light emitting diodes 5 and the fluorescent lamp tubes 61 of the lighting device of this invention are activated at the same time, the fluorescent lamp tubes 61 are used to illuminate a wide area, and the light emitting diodes 5 are used for enhancing brightness of an area thereunder. Accordingly, the lighting device of this invention can form a wide illuminated area, in which a central part of the illuminated area is brighter than a remaining part of the illuminated area.

In this embodiment, the light emitting diodes 5 are arranged in a single row between the fluorescent lamp tubes 61. However, the number of rows of the light emitting diodes 5 and the number of the fluorescent lamp tubes 6l may be adjusted according to design requirements. For instance, the number of rows of the light emitting diodes 5 may be two, and a third fluorescent lamp tube 61 may be disposed between the two rows.

While the lighting device of the first preferred embodiment is illustrated as being suitable for roadside illumination applications, it is apparent to those skilled in the art that the lighting device may be modified for use as a table lamp or a floor lamp in other embodiments of this invention.

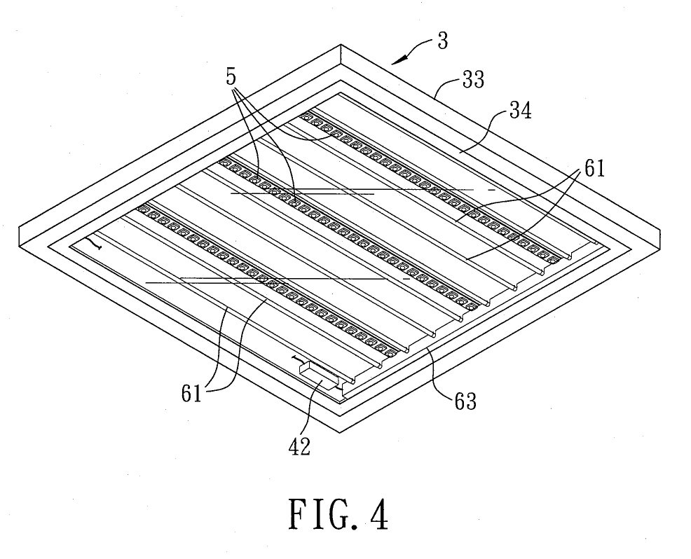

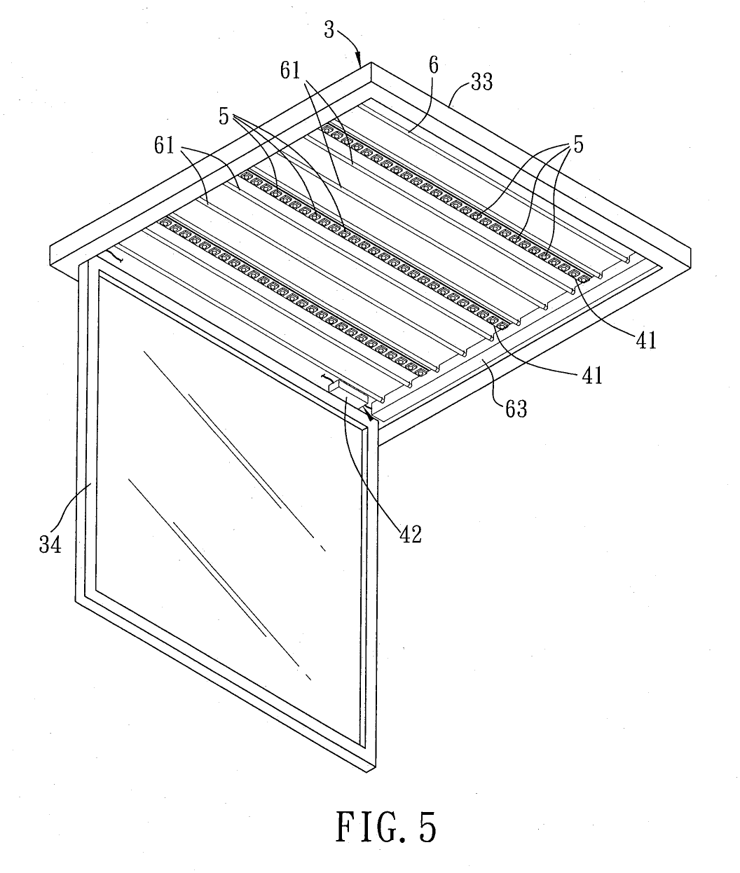

Referring FIGS. 4 and 5, the second preferred embodiment of a lighting device according to the present invention differs from the first preferred embodiment in that the light fixture 3 includes a square-shaped ceiling-mountable case 33 and a transparent shield 34 having one side coupled pivotally to a bottom edge of the ceiling-mountable case 33 for covering and uncovering an open bottom side of the ceiling-mountable case 33. In this embodiment, the ceiling-mountable case 33 of the lighting device is adapted for mounting to a ceiling framework (not shown). The transparent shield may be pivoted downwardly relative to the ceiling-mountable case 33 so as to uncover the open bottom side of the ceiling-mountable case 33.

In this embodiment, the gas-discharge light source 6 includes three pairs of fluorescent lamp tubes 61 that are spaced apart from one another and that extend along the same direction, and a connector unit 63 that is mounted in the light fixture 3 and that connects electrically opposite ends of the fluorescent lamp tubes 61 to the controller 42. The semiconductor light source 4 includes a plurality of circuit boards 41 that are mounted in the light fixture 3, that are spaced apart from one another and that are connected electrically to the controller 42. The semiconductor light source 4 further includes a plurality of light emitting diodes 5 that are arranged in rows, that are mounted on lower sides of the circuit boards 41, and that are connected electrically to the corresponding circuit board 41. Each row of the light emitting diodes 5 is disposed between a corresponding adjacent pair of the fluorescent lamp tubes 61.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A lighting device comprising:
a light fixture;
a semiconductor light source mounted in said light fixture;
a gas-discharge light source mounted in said light fixture; and
a controller disposed in said light fixture, connected electrically to said semiconductor light source and said gas-discharge light source, and operable to control activation and deactivation of said semiconductor light source and said gas-discharge light source.

2. The lighting device as claimed in claim 1, wherein said light fixture includes a lampshade that opens downwardly, and a transparent shield that covers an open bottom side of said lampshade.

3. The lighting device as claimed in claim 1, wherein said light fixture includes a ceiling-mountable case, and a transparent shield coupled pivotally to said ceiling-mountable case for covering and uncovering an open bottom side of said ceiling-mountable case.

4. The lighting device as claimed in claim 1, wherein said semiconductor light source includes a circuit board connected electrically to said controller, and a plurality of light emitting diodes mounted on said circuit board.

5. The lighting device as claimed in claim 1, wherein said gas-discharge light source includes a fluorescent lamp tube and a connector unit to connect electrically said fluorescent lamp tube to said controller.

6. The lighting device as claimed in claim 5, wherein said fluorescent lamp tube is a thermionic emission fluorescent lamp tube.

7. The lighting device as claimed in claim 5, wherein said fluorescent lamp tube is a cold cathode fluorescent lamp tube.

8. The lighting device as claimed in claim 5, wherein said semiconductor light source includes a circuit board connected electrically to said controller, and a plurality of light emitting diodes mounted on said circuit board.

9. The lighting device as claimed in claim 8, wherein said light emitting diodes are arranged on said circuit board along a direction parallel to an extension direction of said fluorescent lamp tube.
